(19) United States
(12) Patent Application Publication
(10) Pub. No.: US 2008/0113633 A1
(43) Pub. Date: May 15, 2008

(54) Apparatus and method for TX mode feedback in communication system

(75) Inventor: Jae-Woo So, Bucheon-si (KR)

Correspondence Address: DOCKET CLERK, P.O. DRAWER 800889, DALLAS, TX, 75380, US

(73) Assignee: SAMSUNG ELECTRONICS Co., Ltd., Suwon-si (KR)

(21) Appl. No.: 11/985,121

(22) Filed: Nov. 14, 2007

(30) Foreign Application Priority Data
Nov. 15, 2006 (KR) 2006-0112535

(51) Int. Cl. H04B 7/02; H04B 1/02

(52) U.S. Cl. 455/101

(57) ABSTRACT

Provided is a method for a MIMO TX mode feedback operation of a user terminal in a MIMO communication system. The user terminal receives allocation information about a feedback channel and a feedback period of a MIMO TX mode from the base station. The user terminal determines whether the current time point is the feedback period of the MIMO TX mode. The user terminal selects a first MIMO TX mode according to channel quality information of a signal received from the base station, at the feedback period of the MIMO TX mode. The user terminal detects a MIMO TX mode of first data received from the base station. The user terminal compares the selected first MIMO TX mode with the detected MIMO TX mode of the first data.

### CROSS-REFERENCE TO RELATED APPLICATION(S) AND CLAIM OF PRIORITY

This application claims priority under 35 U.S.C. §119(a) to an application filed in the Korean Intellectual Property Office on Nov. 15, 2006 and allocated Serial No. 2006-112535, the contents of which are incorporated herein by reference.

### TECHNICAL FIELD OF THE INVENTION

The present invention relates generally to a Multi-Input, Multi-Output (MIMO) communication system, and in particular, to an apparatus and method for selecting at a user terminal a MIMO transmit (TX) mode of a base station and reporting the selected MIMO TX mode to the base station.

### BACKGROUND OF THE INVENTION

Examples of a broadband wireless access (BWA) communication system are an Institute of Electrical and Electronics Engineers (IEEE) 802.16 system and a MIMO Orthogonal Frequency Division Multiple Access (OFDMA) system. In the BWA communication system, a base station allocates a user terminal a feedback channel for reporting a forward channel state. At this point, the base station also allocates the MIMO-supporting user terminal a multiple-input, multiple-output transmit (MIMO TX) mode feedback period value. The MIMO TX mode feedback period is represented in units of the number of times of allocation of a Channel Quality Indicator CHannel (CQICH). In this context, the user terminal reports a forward channel state value to the base station every time it is allocated a CQICH. When the number of times of the CQICH allocation corresponds to the MIMO TX mode feedback period value received from the base station, the user terminal reports the MIMO TX mode information (instead of the forward channel state value) to the base station.

Examples of the MIMO TX mode are a space-time coding (STC) mode and a spatial multiplexing (SM) mode. In general, if a receive (RX) signal-to-noise ratio (SNR) or a carrier-to-interference and noise ratio (CINR) is high, a user terminal uses the SM mode. If the RX SNR is low, the user terminal uses the STC mode. The STC mode can provide an SNR performance gain, whereas the SM mode can increase a data rate in proportion to the number of antennas under the same resource. Therefore, in the environment of a high SNR or CINR, the SM mode provides a larger performance gain than the STD mode. The user terminal selects a MIMO TX mode according to a channel state and transmits feedback information about the selected MIMO TX mode to a base station. Depending on the MIMO TX mode feedback information received from the user terminal, the base station allocates resources to the user terminal in the STC mode or in the SM mode.

FIG. 1 is a flowchart illustrating a conventional procedure for an operation of a user terminal for MIMO TX mode feedback.

Referring to FIG. 1, the user terminal receives allocation information about a feedback channel and a MIMO TX mode feedback period from a serving base station in step 102. In step 104, the user terminal determines whether the current time point is the received MIMO TX mode feedback period. If the current time point is the MIMO TX mode feedback period (in step 104), the user terminal selects a suitable MIMO TX mode in step 106. In step 107, the user terminal transmits the selected MIMO TX mode to the base station through the feedback channel.

However, the above conventional method has the following limitations.

There is a case where the user terminal transmits a value for change of the MIMO TX mode to the base station through the feedback channel but the base station fails to receive the value from the user terminal. In this case, the base station cannot apply a MIMO TX mode to the user terminal until the user terminal transmits a MIMO TX mode value to the base station in the next MIMO TX mode. Thus, the base station has no choice but to use the previous MIMO TX mode to perform resource allocation. Therefore, the MIMO performance gain decreases because the base station performs resource allocation without accurately reflecting the channel environments of the user terminal. For example, if the base station fails to receive the MIMO TX mode feedback value under the condition that the user terminal wants to change the MIMO TX mode from the STC mode to the SM mode, it has no choice but to continue to perform resource allocation in the STC mode. In this case, the performance may degrade because the base station continues to perform resource allocation in the STC mode although the SM mode can provide a performance gain over the STC mode. On the other hand, if the base station fails to receive the MIMO TX mode feedback value under the condition that the user terminal wants to change the MIMO TX mode from the SM mode to the STC mode, it has no choice but to continue to perform resource allocation in the SM mode even in a low-SNR environment. In this case, the user terminal may fail to correctly decode data received in the SM mode.

Also, the conventional method is inefficient in terms of resource occupancy because the user terminal must transmit the MIMO TX mode value to the base station at the MIMO TX mode feedback periods even when the user terminal does not want to change the MIMO TX mode (i.e., even when the user terminal wants to main the allocated MIMO TX mode). In addition, the conventional method may cause an interference with a neighbor cell due to the frequent feedback of the MIMO TX mode.

### SUMMARY OF THE INVENTION

To address the above-discussed deficiencies of the prior art, it is a primary object of the present invention to substantially solve at least the above problems and/or disadvantages and to provide at least the advantages below. Accordingly, an object of the present invention is to provide an apparatus and method for feeding back a MIMO TX mode by efficient use of resources.

Another object of the present invention is to provide an apparatus and method for retransmitting a desired MIMO TX mode of a user terminal directly according to the radio environments of the user terminal even when a reception error occurs in a base station.

According to one aspect of the present invention, a method for a feedback operation of a user terminal for selecting a MIMO TX mode for transmission of data from the user terminal to a base station and feeding back the selected MIMO TX mode to the base station in a MIMO communication system includes the steps of: receiving allocation information about a feedback channel and a feedback period of a MIMO TX mode from the base station; determining whether the current time point is the feedback period of the MIMO TX mode; selecting a first MIMO TX mode according to channel quality information of a signal received from the base station, at the feedback period of the MIMO TX mode; detecting a MIMO TX mode of first data received from the base station; and comparing the selected first MIMO TX mode with the detected MIMO TX mode of the first data.

According to another aspect of the present invention, a method for an operation of a base station for transmitting data through a MIMO TX mode received from a user terminal in a MIMO communication system includes the steps of: allocating allocation information about a feedback channel and a feedback period of a MIMO TX mode to the user terminal; receiving a feedback signal including a first MIMO TX mode from the user terminal; setting a MIMO TX mode according to the first MIMO TX mode included in the feedback signal; and transmitting data to the user terminal in the first MIMO TX mode until receipt of a second MIMO TX mode from the user terminal.

According to still another aspect of the present invention, an apparatus for a feedback operation of a user terminal for selecting a MIMO TX mode for transmission of data from the user terminal to a base station and feeding back the selected MIMO TX mode to the base station in a MIMO communication system includes: a data receiver for receiving allocation information about a feedback channel and a feedback period of a MIMO TX mode from the base station; a TX mode processor for determining whether the current time point is the feedback period of the MIMO TX mode, selecting a first MIMO TX mode for the base station according to the determination results, detecting a MIMO TX mode of first data received from the base station, and comparing the selected first MIMO TX mode with the detected MIMO TX mode of the first data; and a feedback signal processor for generating a MIMO TX mode signal to be fed back according to the comparison results of the TX mode processor.

According to even another aspect of the present invention, an apparatus for an operation of a base station for transmitting data to a user terminal in a MIMO TX mode in a MIMO communication system includes: a feedback information processor for determining allocation information about a feedback channel and a feedback period of a MIMO TX mode, receiving a feedback signal including a first MIMO TX mode from the user terminal, and extracting the first MIMO TX mode included in the feedback signal; and a TX mode control processor for transmitting data to the user terminal in the first MIMO TX mode until receipt of a second MIMO TX mode from the user terminal.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a flowchart illustrating a conventional procedure for an operation of a user terminal for MIMO TX mode feedback;

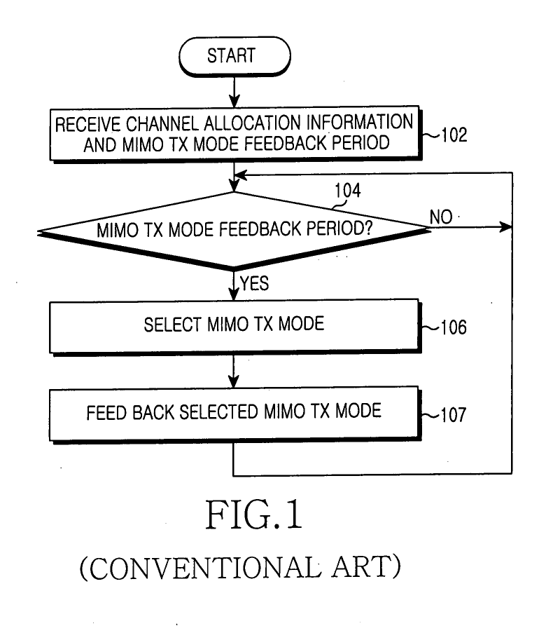

FIG. 2 is a block diagram of a user terminal for MIMO TX mode feedback according to an embodiment of the disclosure;

FIG. 3 is a block diagram of a base station for receiving MIMO TX mode feedback information and applying a corresponding MIMO TX mode according to an embodiment of the disclosure;

FIG. 4 is a flowchart illustrating a procedure for an operation of a user terminal for MIMO TX mode feedback according to an embodiment of the disclosure; and

FIG. 5 is a flowchart illustrating a procedure for an operation of a base station for receiving MIMO TX mode feedback information and applying a corresponding MIMO TX mode according to an embodiment of the disclosure.

### DETAILED DESCRIPTION OF THE INVENTION

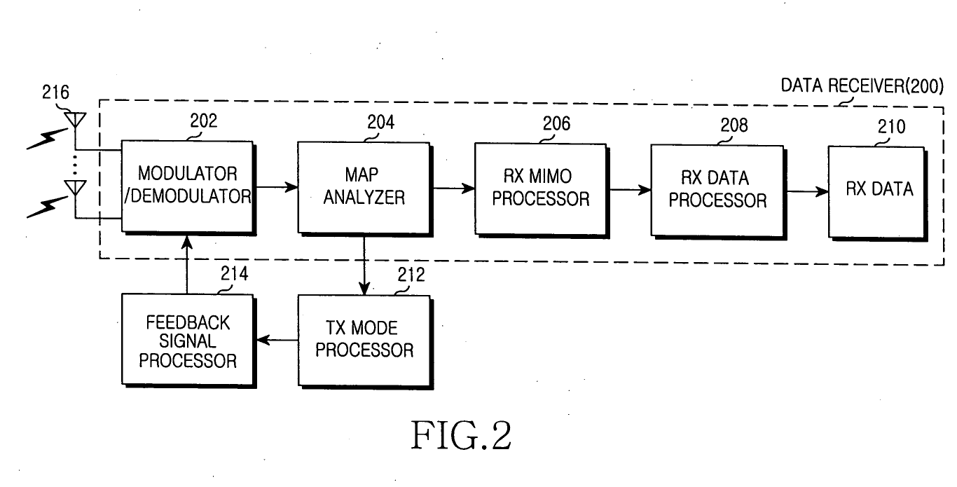

FIGS. 2 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The present invention is intended to provide a scheme for feeding back a MIMO TX mode by efficient use of resources and retransmitting a desired MIMO TX mode of a user terminal directly according to the radio environments of the user terminal even when a reception error occurs in a base station.

The following description is made in the context of an IEEE 802.16e communication system, to which the present invention is not limited. Thus, it is to be clearly understood that the MIMO TX mode feedback scheme of the present invention is applicable to any other communication system as well as to the IEEE 802.16e communication system.

FIG. 2 is a block diagram of a user terminal for MIMO TX mode feedback according to an embodiment of the present invention.

Referring to FIG. 2, the user terminal includes a data receiver 200, a MIMO TX mode processor 212, a feedback signal processor 214, and an antenna unit 216 for transmission and reception of data. The antenna unit 216 receives a radio signal transmitted from a base station. The radio signal includes control information and a data signal to which a MIMO TX mode is applied. Examples of the MIMO TX mode are an STC mode and an SM mode. A typical example of the STC mode for maximization of TX reliability is an Alamouti STC mode using two effective TX antennas. The SM mode can increase a data rate by transmitting different data streams through different antennas.

The MIMO TX mode may be classified into several modes depending on the number of transmit (TX) antennas and a predetermined STC matrix. For example, the MIMO TX mode may be classified into a vertical mode and a horizontal mode depending on whether data can be transmitted by applying forward error correction (FEC) for each antenna. Also, the MIMO TX mode can be classified into a closed-loop mode for allowing a receiver to feed back selected information in order to select a space-time code or an antenna of the transmitter or for allowing the receiver to feed back receive (RX) channel information to the transmitter by using a mapped codebook and a channel state, and an open-loop mode irrelevant to the above feedback information. A detailed description of the respective MIMO TX modes will be omitted for conciseness.

The data receiver 200 includes a modulator/demodulator 202, a map analyzer 204, an RX MIMO processor 206, and an RX data processor. The data receiver 200 decodes a radio signal received from the antenna unit 216. The modulator/demodulator 202 demodulates the received radio signal by a demodulator corresponding to a modulation scheme of the transmitter. The following description is made on the assumption that the radio signal is modulated in an Orthogonal Frequency Division Multiplexing (OFDM) scheme.

The modulator/demodulator 202 demodulates the OFDM radio signal by Fast Fourier Transform (FFT). The map analyzer 204 analyzes map information or control information included in the modulated signal received from the modulator/demodulator 202, thereby obtaining location information of data, allocation information about a feedback channel, a MIMO TX mode, and feedback period information of the MIMO TX mode. In the case of the IEEE 802.16 system, resource allocation information of a CQICH is included in allocation control information of the CQICH that is an uplink feedback channel that a base station allocates to a user terminal. The allocation control information of the CQICH includes feedback period information of the MIMO TX mode, and the number of times of the CQICH allocation may be used as a unit of the feedback period. In this context, the user terminal feeds back channel quality information to the base station by using the CQICH allocated by the base station. When the number of times of the CQICH allocation corresponds to the feedback period of the MIMO TX mode, the user terminal feed backs a selected MIMO TX mode to the base station through the CQICH.

The map information or the control information may include MIMO downlink map information. The MIMO downlink map information may be used to inform a MIMO TX mode so that the user terminal can decode data from the base station according to the MIMO TX mode. For example, matrixes mapped to MIMO TX modes are set, and a matrix corresponding to a TX mode may be included in the MIMO downlink map information by setting an indicator field or a field indicating the number of TX streams.

Thus, it can be determined by the map analyzer 204 whether the decoded signal is a MIMO TX signal or a general data signal. If the decoded signal is a MIMO TX signal, it is possible to detect what is a MIMO TX mode applied by the base station. If the decoded signal is the MIMO TX signal to which the MIMO TX mode is applied, the RX MIMO processor 206 decodes the MIMO signal in accordance with the applied MIMO TX mode. If the decoded signal is a general data signal (not a MIMO TX signal), the RX MIMO processor 206 simply transmits the decoded signal to the RX data processor without additional signal processing. The RX data processor 208 processes the decoded MIMO signal from the RX MIMO processor 206 to generate RX data 210.

Also, the map analyzer 204 transmits information including allocation information about the feedback channel, the MIMO TX mode, and the feedback period of the MIMO TX mode to the MIMO TX mode processor 212. The MIMO TX mode processor 212 determines whether the current time point is the feedback period of the MIMO TX mode. If the current time point is the feedback period of the MIMO TX mode, the MIMO TX mode processor 212 selects a MIMO TX mode to be used by the base station.

The MIMO TX mode processor 212 determines whether the selected MIMO TX mode is identical to the MIMO TX mode received from the map analyzer 204. If the selected MIMO TX mode is identical to the received MIMO TX mode, the MIMO TX mode processor 212 controls the feedback signal processor 214 so that a feedback signal of the selected MIMO TX mode is not generated at the feedback period of the MIMO TX mode. If the selected MIMO TX mode is different from the received MIMO TX mode, the MIMO TX mode processor 212 controls the feedback signal processor 214 so that a feedback signal of the selected MIMO TX mode is generated at the feedback period of the MIMO TX mode.

If the MIMO TX mode processor 212 controls the feedback signal of the selected MIMO TX mode to be generated, the feedback signal processor 214 selects one of feedback codes mapped to MIMO TX modes according to the selected MIMO TX mode, and encodes the selected feedback code in a predetermined scheme to generate a feedback signal. The feedback signal processor 214 transmits the generated feedback signal to the modulator 202. The modulator 202 modulates the feedback signal in a predetermined modulation scheme to be used for the feedback channel. The antenna unit 216 receives the modulated feedback signal and transmits the received signal to the base station. As described above, in an embodiment of the present invention, if the MIMO TX mode selected by the user terminal is identical to the MIMO TX mode received from the base station, the feedback is not transmitted to the base station, thereby preventing the unnecessary occupation of radio resources.

Another embodiment of the present invention provides an apparatus for retransmitting the selected MIMO TX mode at the next feedback channel allocation period without waiting transmission of feedback information till the feedback period of the MIMO TX mode, when the base station fails to receive the selected MIMO TX mode fed back from the user terminal and thus uses the previous MIMO TX mode for transmission from the user terminal. As described above, if the selected MIMO TX mode is different from the received MIMO TX mode, the MIMO TX mode processor 212 controls the feedback signal processor 214 to generate a feedback signal. The generated feedback signal is modulated by the modulator 202 and the modulated feedback signal is transmitted through the antenna unit 216 to the base station. Thereafter, a new signal is received from the base station through the antenna unit 216, the received new signal is demodulated by the demodulator 202, a MIMO TX mode is detected by the map analyzer 204, and the detected MIMO TX mode is transmitted to the MIMO TX mode processor 212.

At the allocation period of the feedback channel after the transmission of the modulated feedback signal, the MIMO TX mode processor 212 compares the MIMO TX mode of the new signal with the selected previous MIMO TX mode. If the MIMO TX mode is different from the selected MIMO TX mode, the MIMO TX mode processor 212 controls the feedback signal processor 214 to generate a feedback signal of the selected MIMO TX mode. The generated feedback signal is modulated by the modulator 202 and the modulated feedback signal is retransmitted through the antenna unit 216 to the base station. Because the retransmission is performed at the allocation of the feedback channel, it may be represented in units of the number of times of the feedback channel allocation and may be limited to the predetermined feedback number. If the MIMO TX mode is identical to the selected MIMO TX mode, the MIMO TX mode processor 212 controls the feedback signal processor 214 not to generate a feedback signal, and waits till the feedback period of the next MIMO TX mode. A detailed operation will be described below.

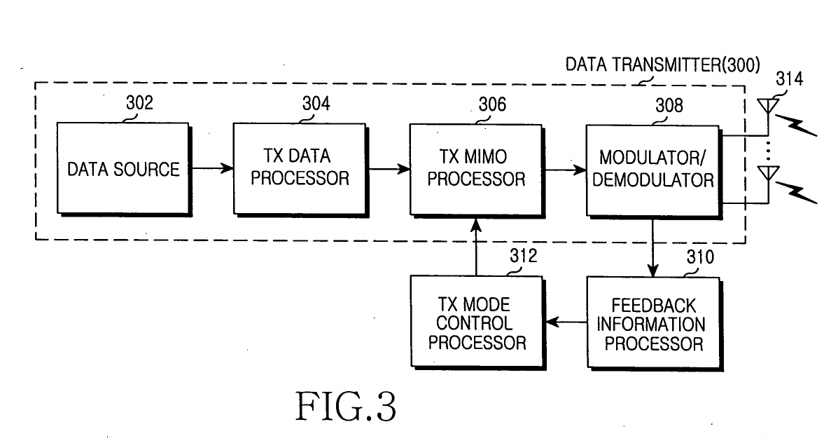

FIG. 3 is a block diagram of a base station for receiving MIMO TX mode feedback information and applying a corresponding MIMO TX mode according to an embodiment of the present invention.

Referring to FIG. 3, the base station includes a data transmitter 300, a feedback information processor 310, a transmit (TX) mode control processor 312, and an antenna unit 314. The data transmitter 300 includes a transmit (TX) data processor 304, a TX MIMO processor 306, and a modulator/demodulator 308. The TX data processor 304 encodes a data source 302 into TX data. The TX MIMO processor 306 processes the encoded TX data in accordance with a MIMO TX mode received from the TX mode controller processor 312. When a MIMO mode is not applied, the TX MIMO processor 306 sends the encoded TX data to the modulator/demodulator 308 without additional signal processing.

In an embodiment of the present invention, even when the MIMO mode is not applied, information about the MIMO TX mode, such as map or control information including allocation information about a feedback channel, a MIMO TX mode, and feedback period information of the MIMO TX mode may be included in a TX signal at the TX MIMO processor 306. The modulator/demodulator 308 modulates the TX signal from the TX MIMO processor 306 in accordance with a predetermined modulation scheme. For example, the TX signal may be OFDM-modulated by Inverse Fast Fourier Transform (IFFT). The modulated TX signal is transmitted through the antennal unit 314 to the corresponding user terminal.

Hereinafter, a description is given of a procedure for receiving at the base station a feedback signal for a MIMO TX mode from the user terminal and applying the received MIMO TX mode to the base station. The antenna unit 314 receives a feedback signal for a MIMO TX mode from the user terminal. As described above, the feedback signal includes information about a MIMO TX mode. A feedback signal demodulated by the demodulator 308 is transmitted to the feedback information processor 310. The demodulator 308 performs modulation in a predetermined demodulation scheme used for the feedback channel. The feedback information processor 310 extracts a MIMO TX mode from the demodulated feedback signal received from the demodulator 308. The feedback information processor 310 transmits the extracted MIMO TX mode to the TX mode control processor 312. Also, the feedback information processor 310 may determine allocation information about the feedback channel of the user terminal and a feedback period of a MIMO TX mode, and may transmit the determined information to the TX mode control processor 312.

Until receipt of a new MIMO TX mode of the user terminal from the feedback information processor 310, the TX mode control processor 312 controls the TX MIMO processor 306 to transmit data to the user terminal in the received MIMO TX mode. Upon receipt of the allocation information about the feedback channel and the feedback period of the MIMO TX mode from the feedback information processor 310, the TX mode control processor 312 controls the received information to be included in the TX signal. In an embodiment of the present invention, the time point when the TX mode control processor 312 receives and processes the user terminal's MIMO TX mode from the feedback information processor 310 may be determined using only an RX time point corresponding to the feedback period of the user terminal's MIMO TX mode. In this case, the MIMO TX mode is transmitted to the TX mode control processor 312 only when it is received, so that the maintained MIMO TX mode is used as the received MIMO TX mode.

In another embodiment of the present invention, if feedback information about the MIMO TX mode of the user terminal fails to be received at the time point corresponding to the feedback period of the MIMO TX mode of the user terminal, it may be designed to detect a signal received for a predetermined time period. For example, the predetermined time period may be set to be a predetermined number of time periods in units of the number of times of the feedback channel allocation for the user terminal. If the feedback information about the MIMO TX mode of the user terminal fails to be received at the time point corresponding to the feedback period of the MIMO TX mode of the user terminal, a feedback signal is detected at RX periods for a feedback signal corresponding to the feedback channel allocation period during the predetermined time period from the time point until there is a feedback signal of the user terminal. According to the above embodiments, when the base station fails to receive the MIMO TX mode feedback signal of the user terminal, it can detect the retransmitted MIMO TX mode feedback signal without waiting till the feedback period of the next MIMO TX mode and can apply the detected MIMO mode to data transmission.

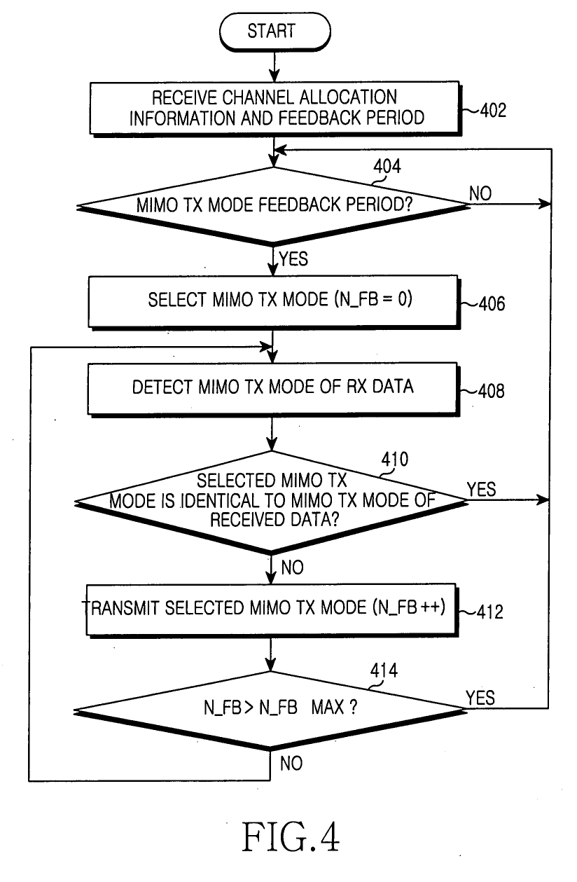

FIG. 4 is a flowchart illustrating a procedure for an operation of a user terminal for MIMO TX mode feedback according to an embodiment of the present invention.

Referring to FIG. 4, the user terminal receives control information including feedback channel allocation information and a MIMO TX mode feedback period from the corresponding base station in step 402. In step 404, the user terminal determines whether the current time point corresponds to the received MIMO TX mode feedback period. If the current time point corresponds to the received MIMO TX mode feedback period, the user terminal selects and determines a suitable MIMO TX mode of the base station. In step 406, the user terminal initializes the feedback number N_FB (the number of feedbacks) to 0. In step 408, the user terminal detects a MIMO TX mode of data received from the base station.

In step 410, the user terminal determines whether a MIMO TX mode selected by the user terminal is identical to the MIMO TX mode of the received data. If the selected MIMO TX mode is identical to the MIMO TX mode of the received data, the procedure returns to step 404 to again check the feedback period of the MIMO TX mode. On the other hand, if the selected MIMO TX mode is different from the MIMO TX mode of the received data, the procedure proceeds to step 412. In step 412, the user terminal transmits a feedback signal of the selected MIMO TX mode and increases the feedback number N_FB by 1.

In step 414, the user terminal determines whether the increased feedback number N_FB is larger than a predetermined maximum feedback number N_FB MAX. If the increased feedback number N_FB is larger than the maximum feedback number N_FB MAX, the procedure returns to step 404 to again check the feedback period of the MIMO TX mode. On the other hand, if the increased feedback number N_FB is larger than the maximum feedback number N_FB MAX, the procedure returns to step 408 to detect a MIMO TX mode of new data received from the base station.

In step 410, the user terminal determines whether the selected MIMO TX mode is identical to the MIMO TX mode of the new data. If the selected MIMO TX mode is identical to the MIMO TX mode of the new data, because the selected MIMO TX mode is applied to the base station, the procedure returns to step 404 to again check the feedback period of the MIMO TX mode. On the other hand, if the selected MIMO TX mode is different from the MIMO TX mode of the new data, the user terminal retransmits the selected MIMO TX mode and increases the feedback number N_FB by 1 in step 412. The transmission time point is a time point corresponding to the feedback channel allocation period after the MIMO mode feedback period.

As described above, the MIMO TX mode feedback period may be represented in units of the number of times of the feedback channel allocation. Thus, according to an embodiment of the present invention, if the feedback period is 4, the user terminal may feed back the selected MIMO TX mode in the next one feedback channel allocation period without waiting for a time period of the four feedback channel allocation periods that is the next MIMO mode feedback period. In this way, according to an embodiment of the present invention, the receive (RX) state of the user terminal can be reflected directly in the MIMO TX mode of the base station, thus improving the system performance.

In step 414, the user terminal determines whether the increased feedback number N_FB is larger than the maximum feedback number N_FB MAX. The determination of whether the increased feedback number N_FB is larger than the maximum feedback number N_FB MAX is to prevent the interference and the unnecessary occupation of radio resources that are caused by the frequent transmission of the feedback signal. According to an embodiment, if the maximum feedback number N_FB MAX is set to 0, the selected MIMO TX mode may not be retransmitted. According to another embodiment, if the maximum feedback number N_FB MAX is set to be larger than 0 and smaller than the feedback period of the MIMO TX mode, the feedback signal may be retransmitted as many times as the set N_FB MAX value.

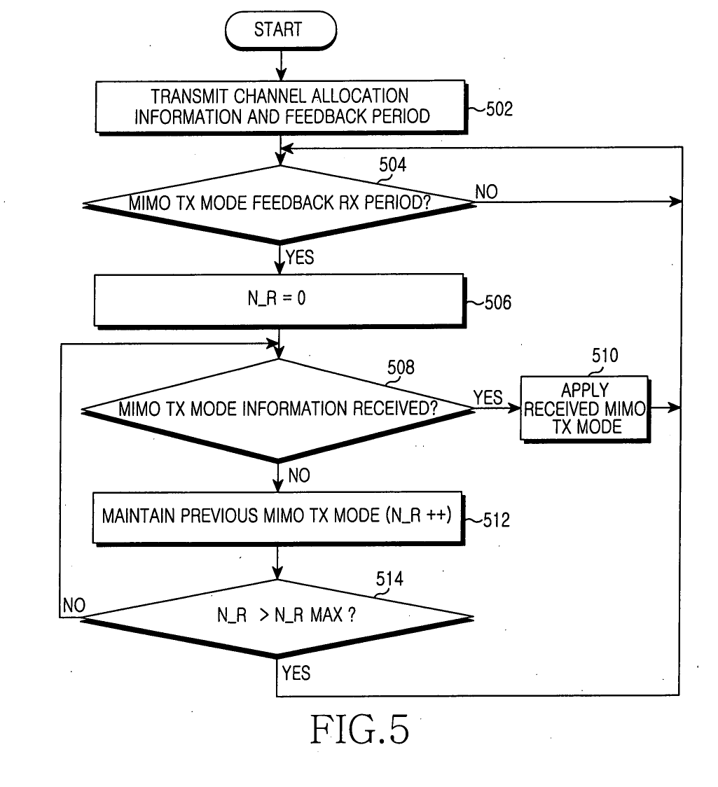

FIG. 5 is a flowchart illustrating a procedure for an operation of a base station for receiving MIMO TX mode feedback information and applying a corresponding MIMO TX mode according to an embodiment of the present invention.

Referring to FIG. 5, the base station transmits feedback channel allocation information and a MIMO TX mode feedback period to the corresponding user terminal in step 502. In step 504, the base station determines whether the current time point is an RX period of a MIMO TX mode feedback signal corresponding to the MIMO TX mode feedback period. If the current time point is the RX period of the MIMO TXD mode feedback signal, in step 506, the base station initializes the feedback signal reception number N_R (the number of times of reception of a feedback signal) to 0.

In step 508, the base station determines whether the MIMO TX mode feedback signal is received from the user terminal. If the MIMO TX mode feedback signal is received from the user terminal (in step 508), the procedure proceeds to step 510. In step 510, the base station applies a MIMO TX mode, which is represented by or included in the feedback signal, to data to be transmitted to the user terminal. Thereafter, the procedure returns to step 504 to check the RX period of the MIMO TX mode feedback signal.

On the other hand, if the MIMO TX mode feedback signal is not received from the user terminal (in step 508), the procedure proceeds to step 512. In step 512, the base station controls the user terminal to maintain the previous MIMO TX mode for data transmission and increases the feedback signal reception number N_R by 1. In step 514, the base station determines whether the increased feedback signal reception number N_R is larger than the maximum feedback signal reception number N_R MAX. If the increased feedback signal reception number N_R is larger than the maximum feedback signal reception number N_R MAX, the procedure returns to step 504 to check the feedback RX period. On the other hand, if the increased feedback signal reception number N_R is not larger than the maximum feedback signal reception number N_R MAX, the procedure returns to step 508 to determine whether MIMO TX mode information is received from the user terminal in the next feedback channel allocation period. In this way, steps 508 through 514 are repeated depending on the set reception times.

According to an embodiment, if the maximum feedback signal reception number N_R MAX is set to 0, the recheck may not be performed at the next feedback signal RX time point. According to another embodiment, if the maximum feedback signal reception number N_R MAX is set to be larger than 0 and smaller than the feedback period of the MIMO TX mode, the reception of the feedback signal may be checked for a time period corresponding to as many feedback channel allocation periods as the N_R MAX times until the feedback signal is received. According to still another embodiment, the base station always monitors whether MIMO TX mode information is received. If MIMO RX mode information is received, data are transmitted using the received MIMO RX mode. If MIMO RX mode information is not received, the previous MIMO TX mode is maintained.

As described above, the present invention makes it possible to efficiently use resources when a MIMO TX mode is selected and applied to data transmission. Also, even when a base station fails to receive information about the MIMO TX mode from a user terminal, the user terminal can directly retransmit a desired MIMO TX mode and the base station can directly receive the MIMO TX mode again. Therefore, it is possible to reduce the unnecessary occupation of radio resources and an inter-symbol interference and to change the MIMO TX mode efficiently and reliably.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for a feedback operation of a user terminal for selecting a Multi-Input Multi-Output (MIMO) TX mode for transmission of data from the user terminal to a base station and feeding back the selected MIMO TX mode to the base station in a MIMO communication system, the method comprising:
receiving allocation information about a feedback channel and a feedback period of a MIMO TX mode from the base station;
determining whether the current time point is the feedback period of the MIMO TX mode;
selecting a first MIMO TX mode according to channel quality information of a signal received from the base station, at the feedback period of the MIMO TX mode;
detecting a MIMO TX mode of first data received from the base station; and
comparing the selected first MIMO TX mode with the detected MIMO TX mode of the first data.

2. The method of claim 1, further comprising:
controlling the first MIMO TX mode not to be transmitted at the feedback period of the MIMO TX mode, if the selected first MIMO TX mode is identical to the detected MIMO TX mode of the first data.

3. The method of claim 1, further comprising:
transmitting the first MIMO TX mode at the feedback period of the MIMO TX mode, if the selected first MIMO TX mode is different from the detected MIMO TX mode of the first data.

4. The method of claim 3, further comprising:
detecting a MIMO TX mode of second data received from the base station after transmission of the first MIMO TX mode to the base station;
comparing the first MIMO TX mode with the MIMO TX mode of the second data; and
retransmitting the first MIMO TX mode to the base station if the first MIMO TX mode is different from the MIMO TX mode of the second data.

5. The method of claim 4, wherein the first MIMO TX mode is retransmitted to the base station before the next MIMO TX mode feedback period.

6. The method of claim 4, further comprising:
checking whether the current time point is the feedback period of the MIMO TX mode without retransmitting the first MIMO TX mode, if the first MIMO TX mode is identical to the MIMO TX mode of the second data.

7. The method of claim 4, wherein if the first MIMO TX mode is different from the MIMO TX mode of the second data, the step of retransmitting the first MIMO TX mode to the base station retransmits the first MIMO TX mode if the number of times of retransmission is smaller than a predetermined number of times, or checks whether the current time point is the feedback period of the MIMO TX mode without retransmitting the first MIMO TX mode if the number of times of retransmission is larger than the predetermined number of times.

8. A method for an operation of a base station for transmitting data through a Multi-Input, Multi-Output transmit (MIMO TX) mode received from a user terminal in a MIMO communication system, the method comprising:
allocating allocation information about a feedback channel and a feedback period of a MIMO TX mode to the user terminal;
receiving a feedback signal including a first MIMO TX mode from the user terminal;
setting a MIMO TX mode according to the first MIMO TX mode included in the feedback signal; and
transmitting data to the user terminal in the first MIMO TX mode until receipt of a second MIMO TX mode from the user terminal.

9. The method of claim 8, wherein the second MIMO TX mode is received from the user terminal in a time period different from a time period corresponding to the feedback period of the MIMO TX mode.

10. The method of claim 8, wherein the second MIMO TX mode is received from the user terminal before the arrival of a time period corresponding to the feedback period of the MIMO TX mode.

11. The method of claim 8, wherein the data are transmitted to the user terminal in the first MIMO TX mode if the base station fails to receive the second MIMO TX mode in a time period corresponding to the feedback period of the MIMO TX mode.

12. The method of claim 9, wherein the time period different from a time period corresponding to the feedback period of the MIMO TX mode is a time period within the number of times of allocation of the allocation information about the feedback channel after the time period corresponding to the feedback period of the MIMO TX mode.

13. An apparatus for a feedback operation of a user terminal for selecting a Multi-Input, Multi-Output transmit (MIMO TX) mode for transmission of data from the user terminal to a base station and feeding back the selected MIMO TX mode to the base station in a MIMO communication system, the apparatus comprising:
a data receiver for receiving allocation information about a feedback channel and a feedback period of a MIMO TX mode from the base station;
a TX mode processor for determining whether the current time point is the feedback period of the MIMO TX mode, selecting a first MIMO TX mode for the base station according to the determination results, detecting a MIMO TX mode of first data received from the base station, and comparing the selected first MIMO TX mode with the detected MIMO TX mode of the first data; and
a feedback signal processor for generating a MIMO TX mode signal to be fed back according to the comparison results of the TX mode processor.

14. The apparatus of claim 13, wherein the TX mode processor controls the feedback signal processor not to generate a feedback signal of the first MIMO TX mode in the feedback period of the MIMO TX mode, if the selected first MIMO TX mode is identical to the detected MIMO TX mode of the first data.

15. The apparatus of claim 13, wherein the TX mode processor controls the feedback signal processor to generate a signal for the first MIMO TX mode in the feedback period of the MIMO TX mode, if the selected first MIMO TX mode is different from the detected MIMO TX mode of the first data.

16. The apparatus of claim 15, wherein after the feedback signal processor generates the first MIMO TX mode, the TX mode processor detects a MIMO TX mode of second data received from the base station, compares the first MIMO TX mode with the MIMO TX mode of the second data, and controls the feedback signal processor to re-generate a first MIMO TX mode signal if the first MIMO TX mode is different from the MIMO TX mode of the second data.

17. The apparatus of claim 16, wherein the first MIMO TX mode is retransmitted to the base station before the next MIMO TX mode feedback period.

18. The apparatus of claim 16, wherein if the first MIMO TX mode is identical to the MIMO TX mode of the second data, the TX mode processor controls the feedback signal processor not to re-generate the first MIMO TX mode signal, and checks whether the current time point is the feedback period of the MIMO TX.

19. The apparatus of claim 16, wherein if the first MIMO TX mode is different from the MIMO TX mode of the second data, and when the number of times of re-generation of the first MIMO TX mode signal is smaller than a predetermined number of times, the TX mode processor controls the feedback signal processor to re-generate the first MIMO TX mode signal.

20. The apparatus of claim 16, wherein if the first MIMO TX mode is different from the MIMO TX mode of the second data, and when the number of times of re-generation of the first MIMO TX mode signal is larger than the predetermined number of times, the TX mode processor controls the feedback signal processor controls the feedback signal processor not to re-generate the first MIMO TX mode signal and checks whether the current time point is the feedback period of the MIMO TX.

21. An apparatus for an operation of a base station for transmitting data to a user terminal in a Multi-Input, Multi-Output transmit (MIMO TX) mode in a MIMO communication system, the apparatus comprising:
a feedback information processor for determining allocation information about a feedback channel and a feedback period of a MIMO TX mode, receiving a feedback signal including a first MIMO TX mode from the user terminal, and extracting the first MIMO TX mode included in the feedback signal; and
a TX mode control processor for transmitting data to the user terminal in the first MIMO TX mode until receipt of a second MIMO TX mode from the user terminal.

22. The apparatus of claim 21, wherein the second MIMO TX mode is received from the user terminal in a time period different from a time period corresponding to the feedback period of the MIMO TX mode.

23. The apparatus of claim 21, wherein the second MIMO TX mode is received from the user terminal before the arrival of a time period corresponding to the feedback period of the MIMO TX mode.

24. The apparatus of claim 21, wherein the data are transmitted to the user terminal in the first MIMO TX mode if the base station fails to receive the second MIMO TX mode in a time period corresponding to the feedback period of the MIMO TX mode.

25. The apparatus of claim 22, wherein the time period different from a time period corresponding to the feedback period of the MIMO TX mode is a time period within the number of times of allocation of the allocation information about the feedback channel after the time period corresponding to the feedback period of the MIMO TX mode.
